(19) United States
(12) Patent Application Publication
(10) Pub. No.: US 2010/0288908 A1
(43) Pub. Date: Nov. 18, 2010

(54) Portable container

(76) Inventor: Gary McGraw, Abingdon, MD (US)

Correspondence Address: LITMAN LAW OFFICES, LTD., PATENT LAW BUILDING, 8955 CENTER STREET, MANASSAS, VA, 20110, US

(21) Appl. No.: 12/662,853

(22) Filed: May 6, 2010

Related U.S. Application Data
(60) Provisional application No. 61/213,161, filed on May 12, 2009.

(51) Int. Cl. F16M 11/00; A47G 29/00

(52) U.S. Cl. 248/688; 248/128; 248/157

(57) ABSTRACT

The portable container includes an open upper bucket portion with a single telescoping support column or leg extending concentrically therebeneath. Four feet extend from the lower end of the column, with one foot having an extendible rod therein. A bail or handle extends from the upper portion of the bucket. The device may be used for the carriage of a number of different goods, but is particularly well suited for holding a supply of baseballs or softballs for pitching practice. The device may be deployed at the pitcher's mound, with the foot extension rod providing additional stability when the device is deployed upon the slope of the mound. The low center of gravity of the device when collapsed allows it to be carried within a motor vehicle or the like without undue risk of tipping or spilling of the contents, even when goods are being stored within the bucket portion.

### CROSS-REFERENCE TO RELATED APPLICATION

This application claims the benefit of U.S. Provisional Patent Application Ser. No. 61/213,161, filed May 12, 2009.

### BACKGROUND OF THE INVENTION

1. Field of the Invention

The present invention relates generally to open containers having various adjustable components and more particularly to a portable container supported by a telescoping columnar leg concentric with the container portion, and a laterally telescoping support foot for stability. The device is particularly well suited for holding a supply of baseballs for pitching and batting practice.

2. Description of the Related Art

It is oftentimes desirable to have a portable container for hand carrying and holding various articles as desired or required as they are used or dispensed. An example of such may be found in the games of baseball and softball and related games, where a pitcher may throw innumerable pitches during practice. This is done not only to sharpen the skills of the pitcher, but also those of the batter receiving those pitches.

Conventionally, such practice requires that a catcher be stationed behind the batter's box to catch the pitches and toss the ball back to the pitcher. It will be recognized that this has the effect of slowing the practice, reducing the number of pitches that may be thrown (and the number of swings at such pitches that the batter may take) in any given practice period. As practice time is often limited, it will be seen that this is a potentially serious detriment to the practice of the game.

Thus, a portable container solving the aforementioned problems is desired.

### SUMMARY OF THE INVENTION

The portable container includes an open bucket-like upper portion, with a single telescoping support leg extending downwardly therefrom and aligned concentrically with the upper bucket. A series of four feet extend outwardly from the lower end of the telescoping leg, with one of those feet including an extension that may be extended for additional stability when the device is deployed. The container is particularly well suited for holding baseballs or softballs for convenient access by a pitcher during pitching and batting practice. The device includes a bail or handle to provide for hand carriage of the assembly.

The container is used by carrying it to the desired location and extending the telescoping support leg to raise the bucket to the desired height. The extendible element of one of the feet may be extended as needed to provide additional stability, e.g., on the shallow slope of a pitcher's mound. When pitching practice has been completed, the extendible foot element and the support column are retracted, and the device is compactly stored for future use. The open bucket permits the device to be stored either with goods in the bucket, or with the bucket empty. The low center of gravity of the assembly when the support column is collapsed permits the device to be carried within a motor vehicle without undue risk of tipping or spilling even when the bucket is carrying articles therein.

These and other features of the present invention will become readily apparent upon further review of the following specification and drawings.

### BRIEF DESCRIPTION OF THE DRAWINGS

FIG. 1 is an environmental, perspective view of a portable container according to the present invention, illustrating an exemplary environment and use.

FIG. 2 is an environmental perspective view of the portable container of FIG. 1 in its collapsed configuration, for storage.

FIG. 3 is a side elevation view in section of the portable container of FIG. 1, shown with its various extendible elements in their extended configurations, as in FIG. 1.

FIG. 4 is a side elevation view in section of the portable container of FIG. 1, shown with its various extendible elements in their collapsed configurations, as in FIG. 2.

Similar reference characters denote corresponding features consistently throughout the attached drawings.

### DETAILED DESCRIPTION OF THE PREFERRED EMBODIMENTS

The portable container provides for the carriage and storage of various articles. The container may be vertically adjusted as desired to support the articles within easy reach for a person using the container. While the container is quite versatile and provides for the containment and storage of innumerable articles and materials, it is particularly well suited for use in holding baseballs or softballs for use by a pitcher during pitching and batting practice.

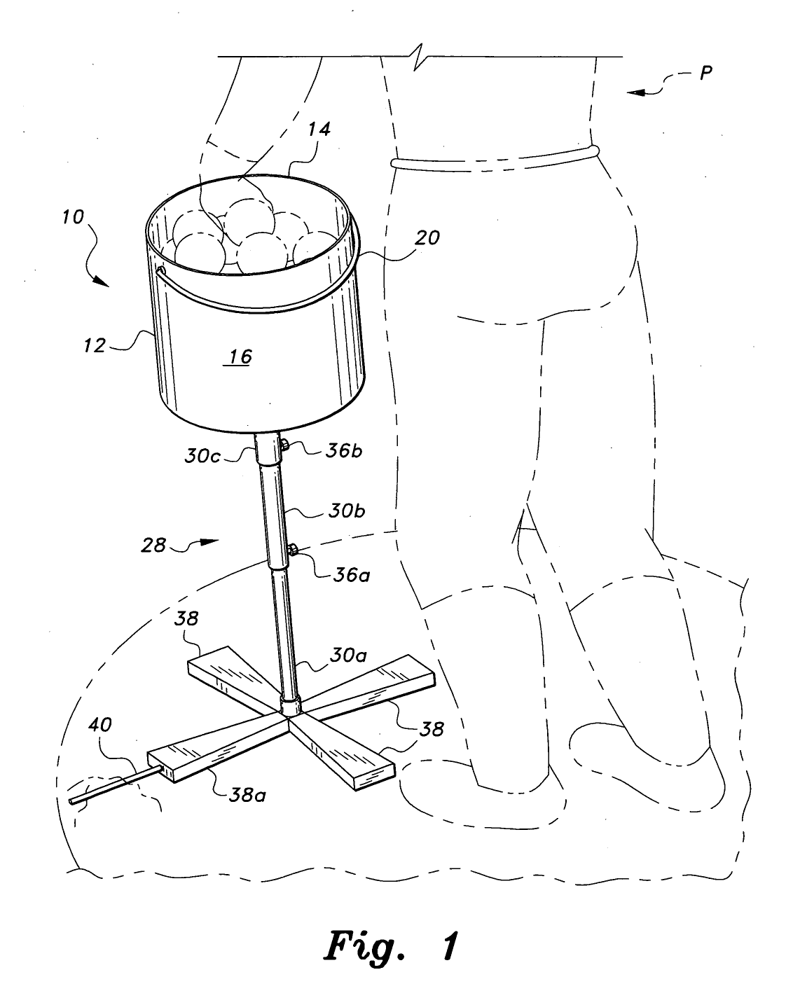

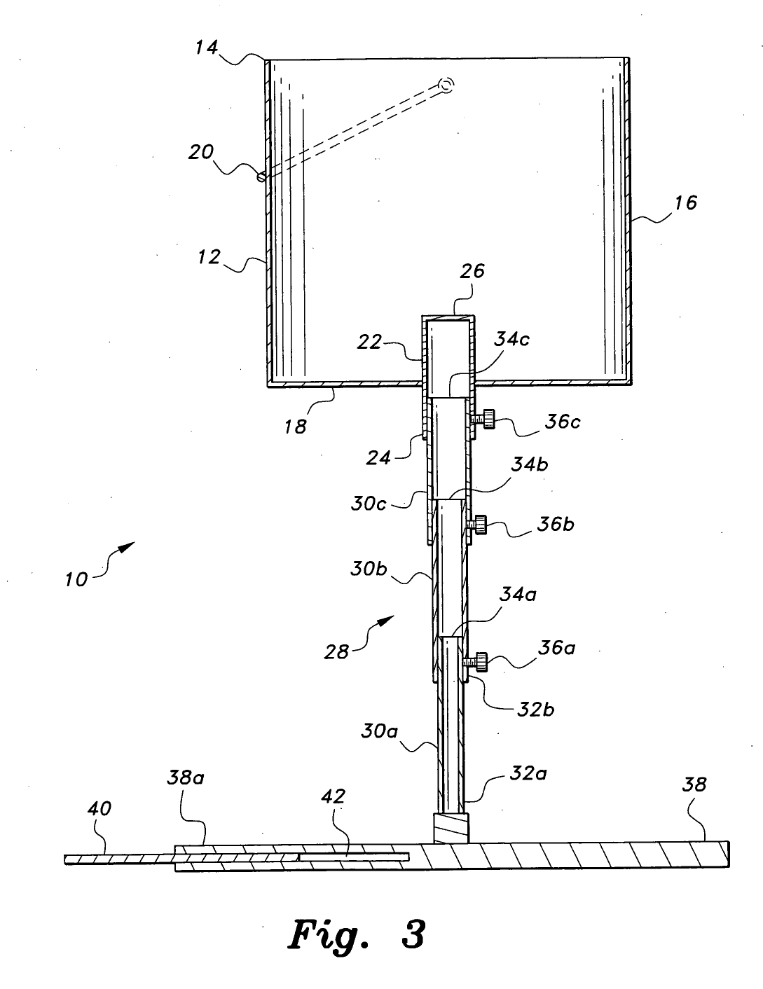

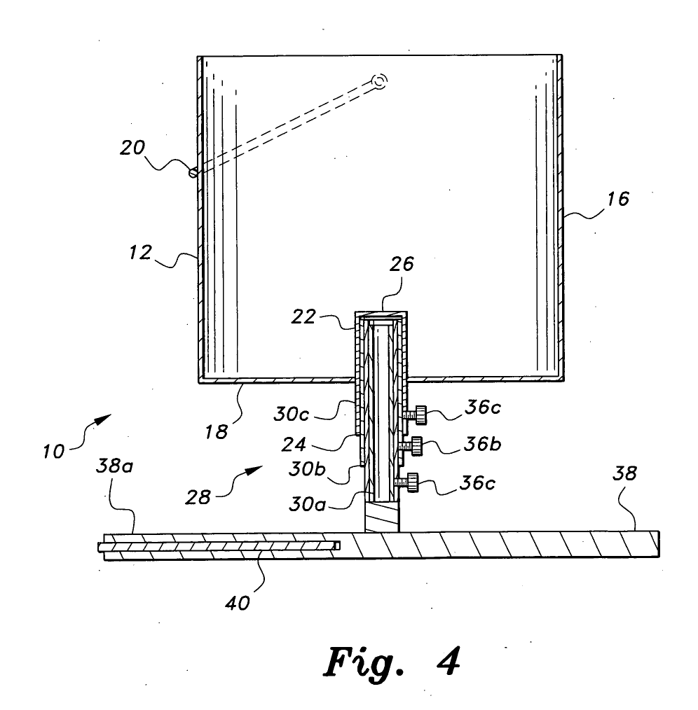

FIG. 1 of the drawings provides an environmental perspective view of the container 10 in use by a pitcher P. The container 10 includes an open bucket 12 having an upper rim 14 with an open top, a sidewall 16, and a floor 18 (shown in FIGS. 3 and 4). While the bucket 12 is of at least a generally cylindrical configuration, it will be seen that the specific shape is not critical and that other shapes (e.g., square, rectangular, oval, etc.) may be used as desired. The circular or cylindrical configuration facilitates orientation on a level surface, as no particular side need be positioned for access by the user. A bail or handle 20 may be installed adjacent the upper rim 14 of the bucket 12 if so desired to extend therefrom, to facilitate carriage of the container10 from place to place as desired.

FIGS. 3 and 4 illustrate further details of the structure of the container 10. A support leg storage sleeve 22 extends through the floor 18 of the bucket 12, with the sleeve 22 having an open lower end portion 24 that depends below the bucket floor 18 to accept a support leg assembly (discussed further below) retractably therein. The sleeve 22 further includes a closed upper end 26, with the sleeve upper end 26, sleeve 22, and bucket floor 18 forming a continuously unbroken surface devoid of passages therethrough. The lack of passages through the bucket enables the bucket to be used for the carriage and storage of liquids, if so desired. The sleeve 22 does not extend particularly high above the floor 18 of the bucket 12, in order to maximize the storage capacity of the bucket 12 and minimize interference with goods and articles carried therein.

A single telescoping support leg assembly 28 extends outwardly or downwardly from the floor 18 of the bucket 12, or more specifically from the lower open end 24 of the sleeve 22, with the support leg assembly 28 being at least generally concentric with and normal to the floor 18 of the bucket 12. The support leg assembly 28 includes a plurality of leg segments, and most preferably includes three mutually telescoping segments comprising a lower segment 30a, medial segment 30b, and upper segment 30c that are at least partially retractable into the sleeve 22. The lowermost leg segment 30a has an outer diameter closely fitting within the internal diameter of the medial segment 30b, with the outer diameter of the medial segment fitting within the inner diameter of the upper segment 30c. The upper segment 30c in turn has an outer diameter fitting closely within the sleeve 22. Each of the segments 30a through 30c has a lower end, respectively 32a through 32c, and an opposite upper end, respectively 34a through 34c. These end portions 32a through 34c are shown in the more detailed view of the extended leg in FIG. 3 of the drawings. The provision of a relatively large number of leg segments 30a through 30c allows each segment to be relatively short in length, while still providing the total extension or elevation desired. This allows the support leg storage sleeve 22 within the bucket 12 to be of a shorter height within the bucket, thereby maximizing the internal space within the bucket.

Radially disposed lower and medial locking screws 36a and 36b are threaded through the walls of the lower portions 32a and 32b of the lower and medial segments 30a and 30b, with a radially disposed upper locking screw 36c being threaded through the wall of the lower end portion 24 of the bucket sleeve 22, i.e., that portion of the sleeve 22 extending below the bucket floor 18. Each of these screws 36a through 36c may be selectively tightened or loosened to lock the two respective leg segments and/or sleeve immovably together, or to allow the segments and/or sleeve to slide relative to one another as desired. Preferably, each of the screws 36a through 36c includes a larger diameter knob extending therefrom, to facilitate manipulation of the screw.

A plurality of feet 38, including a single specialized foot 38a, extends radially from the lower end 32a of the lowermost leg segment 30a in a coplanar array and at least generally normal thereto. The specialized foot 38a includes a support rod or extension 40 that telescopes outwardly therefrom, and resides in a passage 42 disposed essentially along the longitudinal axis of the foot 38a (FIG. 3). The support rod or extension 40 may be extended from the foot 38a as desired to provide greater stability for the container 10 as desired or required, e.g., when the container 10 is deployed for use on the slope of a pitcher's mound or the like. The support rod 40 is retracted into the foot 38a merely by pushing it inwardly, for more compact storage of the device.

The portable container 10 may be used for innumerable purposes as desired, but is particularly well suited for use in holding baseballs or softballs for pitching practice, generally as shown in FIG. 1 of the drawings. The bucket 12 is elevated to the desired height above the feet 38 and 38a by adjusting the leg segments 30a through 30c as desired, and locking them in place relative to one another (and to the sleeve 22) by means of the locking screws 36a through 36c. As no specific or predetermined height settings are provided, the user may adjust the height as desired according to his or her height and personal preferences, without need to elevate the bucket 12 to its maximum height. The bucket 12 may be filled with baseballs, and the container carried out to the pitcher's mound by means of the bail or handle 20. The support rod 40 is then extended as required, e.g., toward the down slope side, to provide greater stability for the container 10 when placed upon a slope, in order to compensate for the higher center of gravity of the elevated bucket 12 with its cargo.

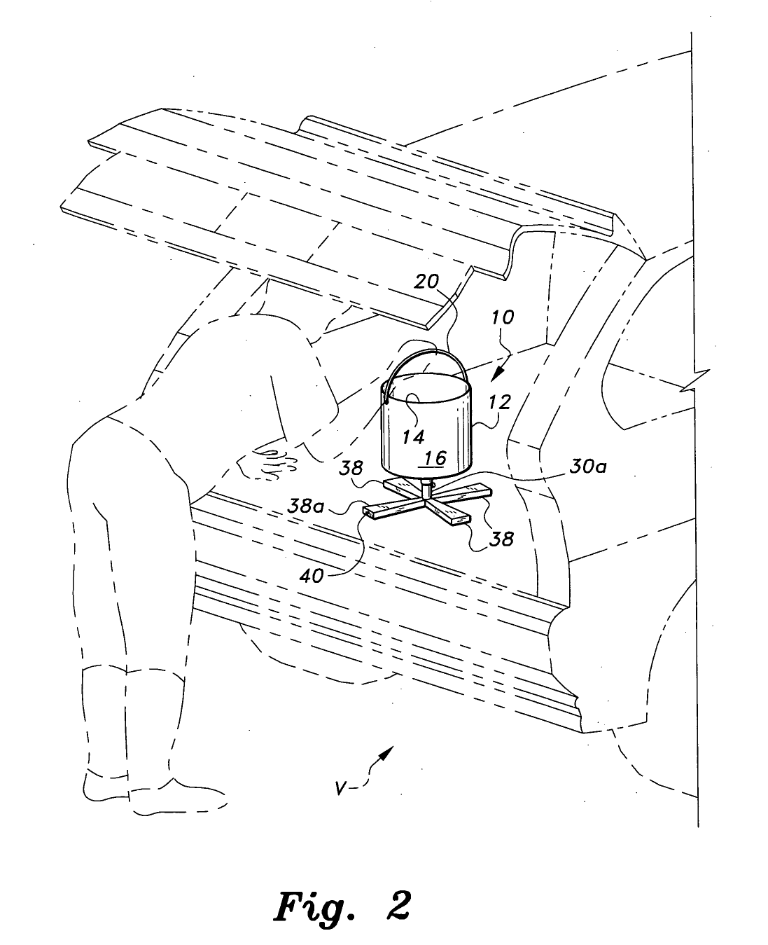

When the container 10 is no longer needed, it may be stored or transported to another location as desired. Relatively compact storage is provided by loosening the three lock screws and sliding the three leg segments 30a through 30c into one another and into the sleeve 22, and locking them together with the lock screws 36a through 36c. The support rod or extension 40 is also retracted into its passage 42 within the foot 38a, as desired. The relatively low height of the container 10 with its collapsed telescoping leg 28 greatly facilitates the transport and storage of the device within the trunk or cargo area of a car, van, or other vehicle V, as shown in FIG. 2. The lower height of the device in such a configuration also lowers the center of gravity of the device, thereby providing greater stability for transport in a moving vehicle, whether the bucket 12 is filled or empty.

The portable container 10 may be used for innumerable purposes, as desired by the user. For example, the device might be used as an inexpensive wine or champagne bucket, particularly for more casual or outdoor dining. Such use is facilitated by the lack of porosity in the bucket portion 12. While the assembly may be constructed of a wide variety of materials, the use of plastic for the bucket 12, leg segments 30a through 30c, and feet 38 and 38a should prove suitable for most uses. A relatively hard and durable plastic material is relatively economical, lightweight for ease of carriage, and resists damage and corrosion. Alternatively, other materials (aluminum or other metals, etc.) may be used as desired. Regardless of the materials or specific use to which the container 10 is put, the device will prove to be a most useful accessory to a great number of people in various activities.

It is to be understood that the present invention is not limited to the embodiment described above, but encompasses any and all embodiments within the scope of the following claims.

I claim:

1. A portable container, comprising:
a bucket having an upper rim, an open top, a sidewall, and a floor;
a single telescoping support leg extending outwardly from the floor concentrically therewith and normal thereto, the support leg having at least three mutually telescoping segments and a lower end; and
a support leg storage sleeve extending through the floor of the bucket, the sleeve having an open lower end portion disposed beneath the floor of the bucket and a closed upper end disposed within the bucket, the sidewall and the floor of the bucket and the sleeve forming a continuous, unbroken surface devoid of passages therethrough, the support leg being at least partially retractable into the sleeve.

2. The portable container according to claim 1, further including:
a plurality of mutually coplanar feet extending radially from the lower end of the support leg substantially normal thereto; and
a support rod telescopically extending from a single one of the feet.

3. The portable container according to claim 1, wherein the support leg has a lower segment, a medial segment, and an upper segment, each of the segments having an upper end and a lower end opposite the upper end, the lower segment having a smaller diameter than the medial segment and being slidable therein, the medial segment having a smaller diameter than the upper segment and being slidable therein, the portable container further comprising set screws extending through the support leg segments and bearing against the next lower segment in order to temporarily fix the height of the support leg.

4. The portable container according to claim 1, further including a bail disposed adjacent the upper rim of the bucket and extending therefrom.

5. The portable container according to claim 1, wherein the bucket is substantially cylindrical.

6. The portable container according to claim 1, further including a plurality of feet extending radially from the lower end of the support leg, said bucket, the support leg, and the feet being formed of plastic.

7. A portable container, comprising:
a bucket having an upper rim, an open top, a sidewall, and a floor;
a support leg extending outwardly from the floor concentrically therewith and normal thereto, the support leg having a lower end;
a plurality of mutually coplanar feet extending radially from the lower end of the support leg substantially normal thereto; and
a support rod telescopically extending from a single one of the feet.

8. The portable container according to claim 7, wherein:
the support leg includes a plurality of mutually telescoping segments; and
a support leg storage sleeve extends through the floor of the bucket, the sleeve having an open lower end portion disposed beneath the floor of the bucket and a closed upper end disposed within the bucket, the sidewall and floor of the bucket and the sleeve forming a continuous, unbroken surface devoid of passages therethrough, the support leg being at least partially retractable into the sleeve.

9. The portable container according to claim 8, wherein the support leg has a lower segment, a medial segment, and an upper segment, each of the segments having an upper end and a lower end opposite the upper end, the lower segment having a smaller diameter than the medial segment and being slidable therein, the medial segment having a smaller diameter than the upper segment and being slidable therein, the portable container further comprising set screws extending through the support leg segments and bearing against the next lower segment in order to temporarily fix the height of the support leg.

10. The portable container according to claim 7, further including a bail disposed adjacent the upper rim of the bucket and extending therefrom.

11. The portable container according to claim 7, wherein the bucket is substantially cylindrical.

12. The portable container according to claim 7, further including a plurality of feet extending radially from the lower end of the support leg, said bucket, the support leg, and the feet being formed of plastic.

13. A portable container, comprising:
a bucket having an upper rim, an open top, a sidewall, and a floor;
a sleeve depending from the floor, the sleeve having an open lower end portion;
a support leg extending outwardly from the floor concentrically therewith and normal thereto, the support leg having a lower segment, a medial segment, and an upper segment, each of the segments having an upper end and a lower end opposite the upper end, the lower segment having a smaller diameter than the medial segment and being slidable therein, the medial segment having a smaller diameter than the upper segment and being slidable therein; and
set screws extending through the support leg segments and bearing against the next lower segment in order to temporarily fix the height of the support leg.

14. The portable container according to claim 13, wherein the sleeve extends through the floor of the bucket, the sleeve having a closed upper end disposed within the bucket, the sidewall and floor of the bucket and the sleeve forming a continuous, unbroken surface devoid of passages therethrough, the support leg being at least partially retractable into the sleeve.

15. The portable container according to claim 13, further including:
a plurality of mutually coplanar feet extending radially from the lower end of the support leg at least generally normal thereto; and
a support rod telescopically extending from a single one of the feet.

16. The portable container according to claim 13, further including a bail disposed adjacent the upper rim of the bucket and extending therefrom.

17. The portable container according to claim 13, wherein the bucket is substantially cylindrical.

18. The portable container according to claim 13, further including a plurality of feet extending radially from the lower end of the support leg, said bucket, the support leg, and the feet being formed of plastic.
